(19) United States
(12) Patent Application Publication
(10) Pub. No.: US 2010/0328246 A1
(43) Pub. Date: Dec. 30, 2010

(54) APPARATUS FOR DETECTING A TOUCH POINT OF A TOUCH PANEL

(75) Inventor: Dong Hwan Cho, Daejeon (KR)

Correspondence Address: LADAS & PARRY LLP, 224 SOUTH MICHIGAN AVENUE, SUITE 1600, CHICAGO, IL, 60604, US

(73) Assignee: HOGAHM TECHNOLOGY CO., LTD., Daejeon (KR)

(21) Appl. No.: 12/918,574

(22) PCT Filed: Dec. 16, 2009
(86) PCT No.: PCT/KR09/07520

§ 371 Date: Aug. 20, 2010

(30) Foreign Application Priority Data
Feb. 9, 2009 (KR) 10-2009-0010209

(51) Int. Cl. G06F 3/041

(52) U.S. Cl. 345/173

(57) ABSTRACT

Disclosed is an apparatus for detecting a touch point of a touch panel, which is used in a reflective camera type touch panel. In the apparatus for detecting a touch point of a touch panel, a whole or part of a side surface of a reflecting portion is formed into a saw shape, thereby overcoming restrictions in an aspect ratio and a size of the touch panel.

### TECHNICAL FIELD

The present invention relates to an apparatus for detecting a touch point of a touch panel, which is used in a reflective camera type touch panel, and more particularly, to an apparatus for detecting a touch point of a touch panel, in which a whole or part of a side surface of a reflecting portion is formed into a saw shape, thereby overcoming restrictions in an aspect ratio and a size of the touch panel.

### BACKGROUND ART

In general, a touch panel is a device for transferring a user's order to a display apparatus, by which a function of a mouse is substituted by a user's finger, a touch pen and the like. The touch panel which is disposed at a front side of an image screen such as LCD, PDP, a projector (front/rear) and the like has an advantage that it is possible to directly write or draw on the image screen at the same time when the user gives an order corresponding to the image screen. The touch panel can be widely used in various fields from a mobile phone to a blackboard or bulletin board, and it may be called an “interactive white board”.

Since the touch panel is disposed at the front side of the image screen of a display apparatus, it has the same size as the image screen. That is, the touch panel generally has an aspect ratio of 4:3 or 16:9, and may have various width-to-height ratios according to its purposes, for example, a width of the touch panel may be longer than a height thereof or vice versa. However, there is a tendency for use of the aspect ratio of 16:9 to be increased due to the appearance of HD broadcasting and recording medium.

The touch panel may be classified into an infrared matrix type, a thin-film resistance type, an electrostatic capacity type, an infrared digital camera type (hereinafter, called “camera type”) and the like.

In the camera type touch panel, cameras are disposed at corner portions of one side of a frame of the touch panel, and an infrared background is formed at the other side of the frame of the touch panel which is opposite to the cameras. Therefore, if an inner area of the frame of the touch panel is touched by a touch object, the cameras capture a scene that the infrared background is partially blocked by the object, thereby determining whether or not the touch panel is touched and a position on the touch panel which is touched by the object. Each component is installed on a glass plate having a good transmittance, and the glass plate assembly is disposed at a front portion of an image screen so as to be corresponded to the image screen. Since a function part (e.g., the camera, the infrared background portion and so on) of the touch panel is located at the frame of the touch panel, there is no a direct mechanical correlation with the object.

According to the number of the objects which can be recognized, the camera type touch panel is classified into a single touch screen which can recognize only a single object and a multi touch screen which can recognize two or more objects. Basically, two cameras are needed to recognize the single object, and three or more cameras are needed to recognize two or more objects. This is caused by that, if one object is placed within a horizontal angle (hereinafter, called “a touch angle”) of the other object which is captured by one camera, it is impossible to precisely recognize the touch angle of the object. Particularly, if the object is placed to be adjacent to the camera, a range of the touch angle of the object is increased, and thus the necessity of using the three or more cameras is further increased.

Meanwhile, the camera type touch panel is further classified into an LED background camera type and a reflective camera type according to a method of illuminating infrared rays and forming the background.

In the LED background camera type touch panel in which infrared LEDs are disposed in the infrared background, the infrared LEDs have to be thickly disposed so that the infrared background is continuously connected when the cameras capture an image of the infrared background. Therefore, as a size of the touch panel is increased, the number of infrared LEDs is increased. Furthermore, since an electric circuit board for mounting the infrared LEDs and other relevant components are required, the manufacturing cost is increased and the manufacturing process is complicated.

In the reflective camera type touch panel, a reflective infrared illuminating device is disposed to be adjacent to a camera that receives reflected infrared rays, and a reflecting surface is disposed at an infrared background that is opposite to the reflective infrared illuminating device, and the infrared background is formed to reflect the illuminated infrared rays toward the reflective infrared illuminating device. In this type of touch panel, since the infrared background is not comprised of any electronic components, but only mechanical and optical components, it has a simple structure. Thus, it is facilely manufactured at a low price, it has high reliability, and there is no restriction of its size.

However, a retro-reflective tape used in the infrared background of the reflective camera type touch panel has a large incident angle as a typical reflecting body has, and also its reflecting efficiency is deteriorated as it is far away from the illuminating device (light source). Thus, there are some restrictions in a size and an aspect ratio of the touch panel.

### DISCLOSURE

### Technical Problem

An object of the present invention is to provide an apparatus for detecting a touch point of a touch panel which can solve the problem of restrictions in the size and the aspect ratio of the touch panel.

### Technical Solution

To achieve the object of the present invention, the present invention provides an apparatus for detecting a touch point of a touch panel 100, comprising a retro-reflective tape 200, 310, 320 which is disposed at a peripheral portion of the touch panel 100; first and second emitting parts 410 and 420 which are spaced apart from each other at one side of the touch panel 100 so as to radiate light to the retro-reflective tape 200, 310, 320; a first light receiving part 510 which receives a first light emitted from the first emitting part 410 and reflected by the retro-reflective tape 200, 310, 320; a first detecting part 610 which which is connected with the first light receiving part 510 so as to detect a first touch angle θ₁° that the first light forms with respect to a first base line 110 as a straight line passing through the first emitting part 410, when the first light is blocked by a touch object T contacted with the touch panel 100; a second light receiving part 520 which receives a second light emitted from the second emitting part 420 and reflected by the retro-reflective tape 200, 310, 320; a second detecting part 620 which is connected with the second light receiving part 520 so as to detect a second touch angle θ₂° that the second light forms with respect to a second base line 120 as a straight line passing through the second emitting part 420, when the second light is blocked by the touch object T contacted with the touch panel 100; and a calculating part 700 which calculates a position of the touch object T using a distance between the first and second emitting part 410 and 420 and the first and second touch angles θ₁° and θ₂°, wherein the retro-reflective tape 200, 310, 320 comprises a saw-like reflecting part 200 which is disposed at a side of the touch panel 100 to which the first and second lights are incident, and which comprises a first inclined surface 201 which is inclined toward the second emitting part 420 so that an incident angle with respect to the second light is 90°, a second inclined surface 202 which is inclined toward the first emitting part 410 so that an incident angle with respect to the first light is 90° and alternately disposed together with the first inclined surface 201 so as to form a saw shape.

Preferably, the first emitting part 410 and the first light receiving part 510 are disposed at one corner portion of one long side of the rectangular touch panel 100, the second emitting part 420 and the second light receiving part 520 are disposed at the other corner portion of the long side of the touch panel 100, and the saw-like reflecting part 200 is disposed at the other long side of the touch panel 100. And the first base line 110 is one short side of the touch panel 100 passing through the first emitting part 410, and the second base line 120 is the other short side of the touch panel 100 passing through the second emitting part 420. And an aspect ratio of the touch panel 100 is 16:9.

Further, the present invention provides an apparatus for detecting a touch point of a touch panel 1100, comprising a retro-reflective tape 1200, 1310, 1320 which is disposed at a peripheral portion of the touch panel 1100; first and second emitting parts 1410 and 1420 which are spaced apart from each other at one side of the touch panel 1100 so as to radiate light to the retro-reflective tape 1200, 1310, 1320; a first light receiving part 1510 which receives a first light emitted from the first emitting part 1410 and reflected by the retro-reflective tape 1200, 1310, 1320; a first detecting part 1610 which is connected with the first light receiving part 1510 so as to detect a first touch angle α₁° that the first light forms with respect to a first base line 1110 as a straight line passing through the first emitting part 1410, when the first light is blocked by a touch object T contacted with the touch panel 1100; a second light receiving part 1520 which receives a second light emitted from the second emitting part 1420 and reflected by the retro-reflective tape 1200, 1310, 1320; a second detecting part 1620 which is connected with the second light receiving part 1520 so as to detect a second touch angle α₂° that the second light forms with respect to a second base line 1120 as a straight line passing through the second emitting part 1420, when the second light is blocked by the touch object T contacted with the touch panel 1100; and a calculating part 1700 which calculates a position of the touch object T using a distance between the first and second emitting part 1410 and 1420 and the first and second touch angles α₁° and α₂°, wherein the retro-reflective tape 1200, 1310, 1320 comprises a first saw-like reflecting part 1320 which is disposed at a side that the first light is incident but the second light is not incident, and which has a first dummy inclined surface 1322 which is inclined toward the first emitting part 1410 so that an incident angle with respect to the first light is 90°, and a first inclined surface 1321 which is alternately disposed with the first dummy inclined surface 1322 to form a saw shape, and a second saw-like reflecting part 1310 which is disposed at a side that the second light is incident but the first light is not incident, and which has a second dummy inclined surface 1311 which is inclined toward the second emitting part 1420 so that an incident angle with respect to the second light is 90°, and a second inclined surface 1312 which is alternately disposed with the second dummy inclined surface 1311 to form a saw shape.

Preferably, the first emitting part 1410 and the first light receiving part 1510 are disposed at one corner portion of one short side of the rectangular touch panel 1100, and the second emitting part 1420 and the second light receiving part 1520 are disposed at the other corner portion of the short side of the touch panel 1100, and the first and second saw-like reflecting parts 1320 and 1310 are disposed at one long side of the touch panel 1100 passing through the second emitting part 1420 and at the other long side of the touch panel 1100 passing through the first emitting part 1410.

Further, the present invention provides an apparatus for detecting a touch point of a touch panel 2100, comprising a retro-reflective tape 2200, 2310, 2320 which is disposed at a peripheral portion of the touch panel 2100; first and second emitting parts 2410 and 2420 which are spaced apart from each other at one side of the touch panel 2100 so as to radiate light to the retro-reflective tape 2200, 2310, 2320; a first light receiving part 2510 which receives a first light emitted from the first emitting part 2410 and reflected by the retro-reflective tape 2200, 2310, 2320; a first detecting part 2610 which is connected with the first light receiving part 2510 so as to detect a first touch angle β₁° that the first light forms with respect to a first base line 2110 as a straight line passing through the first emitting part 2410, when the first light is blocked by a touch object T contacted with the touch panel 2100; a second light receiving part 2520 which receives a second light emitted from the second emitting part 2420 and reflected by the retro-reflective tape 2200, 2310, 2320; a second detecting part 2620 which is connected with the second light receiving part 2520 so as to detect a second touch angle β₂° that the second light forms with respect to a second base line 2120 as a straight line passing through the second emitting part 2420, when the second light is blocked by the touch object T contacted with the touch panel 2100; and a calculating part 2700 which calculates a position of the touch object T using a distance between the first and second emitting part 2410 and 2420 and the first and second touch angles β₁° and β₂°, wherein the retro-reflective tape 2200, 2310, 2320 comprises a first saw-like reflecting part 2210 which is disposed at a side that the first and second lights are incident and which has a first dummy inclined surface 2212 which is inclined toward the first emitting part 2410 so that an incident angle with respect to the first light is 90°, and a first inclined surface 2211 which is alternately disposed with the first dummy inclined surface 2212 to form a saw shape, so that an incident angle with respect to the first light is 0° at at least a part of the first inclined surface 2211, and a second saw-like reflecting part 2220 which is layered with the first saw-like reflecting part 2210 in a thickness direction and which has a second dummy inclined surface 2221 which is inclined toward the second emitting part 2420 so that an incident angle with respect to the second light is 90°, and a second inclined surface 2222 which is alternately disposed with the second dummy inclined surface 2221 to form a saw shape, so that an incident angle with respect to the second light is 0° at at least a part of the first inclined surface 2211.

Preferably, the first saw-like reflecting part 2210 is formed so that an angle of a contacted portion of the first dummy inclined surface 2212 and the first inclined surface 2211 may be 90°, and the second saw-like reflecting part 2220 is formed so that an angle of a contacted portion of the second dummy inclined surface 2221 and the second inclined surface 2222 may be 90°.

### Advantageous Effects

According to the present invention as described above, a whole or part of the retro-reflective tape which is used in the infrared background of the reflective camera type touch panel to reflect the infrared rays is formed into a saw shape, thereby overcoming restrictions in an aspect ratio and a size of the touch panel and embodying the touch panel having various aspect ratios and sizes.

### DESCRIPTION OF DRAWINGS

The above and other objects, features and advantages of the present invention will become apparent from the following description of preferred embodiments given in conjunction with the accompanying drawings, in which:

FIG. 1 is a schematic view according to a first embodiment of the present invention.

FIG. 2 is a partially enlarged view of a retro-reflective tape according to the first embodiment of the present invention.

FIG. 3 is a graph showing a reflection efficiency of a representative retro-reflective tape.

FIG. 4 is a graph showing a reflection efficiency of light radiated from a first emitting part, wherein an aspect ratio is 16:9, the first emitting part is disposed at an upper left corner, and a flat retro-reflective tape is disposed at low and right sides.

FIG. 5 is a schematic view according to a second embodiment of the present invention.

FIG. 6 is a partially enlarged view of a retro-reflective tape according to the second embodiment of the present invention. FIG. 7 is a schematic view according to a third embodiment of the present invention.

FIG. 8 is a partially enlarged view of a first saw-like reflecting part according to the third embodiment of the present invention.

FIG. 9 is a partially enlarged view of a second saw-like reflecting part according to the third embodiment of the present invention.

[Detailed Description of Main Elements]

| | |
|---|---|
| 100: touch panel | 200: saw-like reflecting part |
| 310: left short side reflecting part | |
| 320: right short side reflecting part | |
| 410: first emitting part | 420: second emitting part |
| 510: first light receiving part | |
| 520: second light receiving part | |
| 610: first detecting part | 620: second detecting part |
| 700: calculating part | |
| 1100: touch panel | |
| 1200: lower short side reflecting part | |
| 1310: second saw-like reflecting part | |
| 1320: first saw-like reflecting part | |
| 1410: first emitting part | 1420: second emitting part |
| 1510: first light receiving part | |
| 1520: second light receiving part | |
| 1610: first detecting part | 1620: second detecting part |
| 1700: calculating part | |
| 2100: touch panel | 2200: saw-like reflecting part |
| 2210: first saw-like reflecting part | |
| 2220: second saw-like reflecting part | |
| 2310: left short side reflecting part | |
| 2320: right short side reflecting part | |
| 2410: first emitting part | 2420: second emitting part |
| 2510: first light receiving part | |
| 2520: second light receiving part | |
| 2610: first detecting part | 2620: second detecting part |
| 2700: calculating part | |

### BEST MODE

Hereinafter, the embodiments of the present invention will be described in detail with reference to accompanying drawings.

### First Embodiment

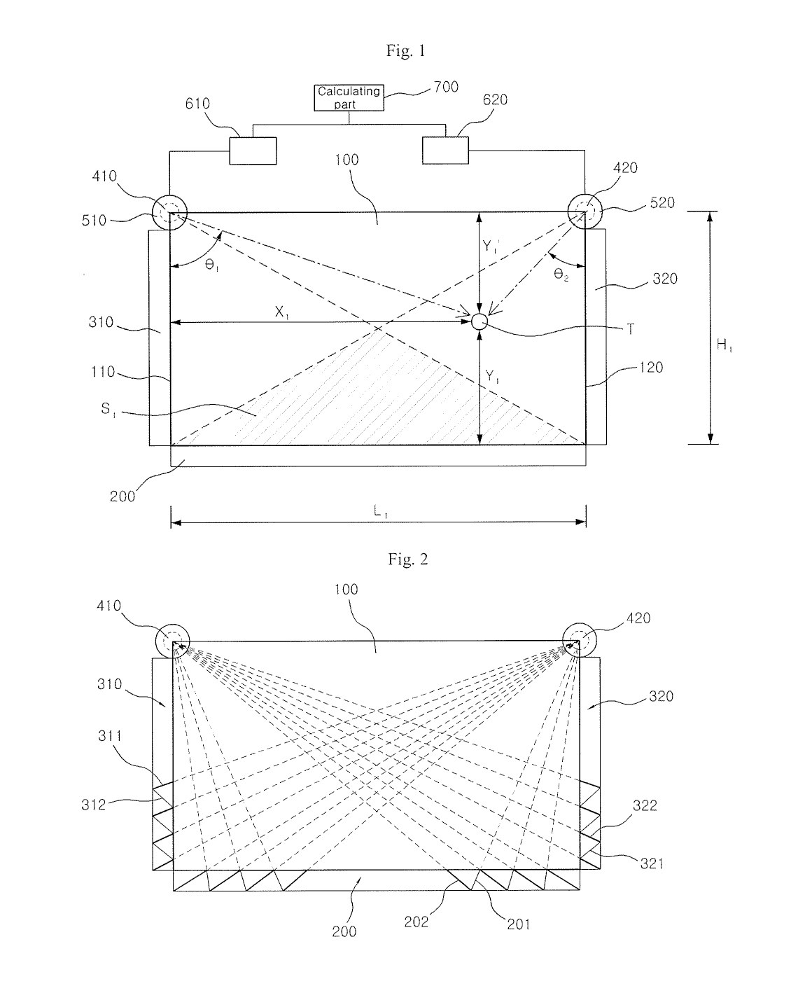

FIG. 1 is a schematic view according to a first embodiment of the present invention, and FIG. 2 is a partially enlarged view of a retro-reflective tape according to the first embodiment of the present invention.

Referring to FIG. 1, the first embodiment includes a touch panel 100. The touch panel 100 is formed into a rectangular shape in which upper and lower sides are long, and right and left sides are short. A length of the long side is designated by L₁, and a length of the short side is designated by H₁. Meanwhile, an aspect ratio L₁:H₁ may be 16:9.

Referring to FIG. 1, a retro-reflective tape 200, 310, 320 is disposed at a peripheral portion of the touch panel 100. The retro-reflective tape 200, 310, 320 is a reflector for reflecting and returning light emitted from a light source in an incident direction, and manufactured by forming fine glass beads or prism on a reflecting surface. Thought the retro-reflective tape is used, there is limitation in performance (reflecting efficiency) of the touch panel. That is, the reflecting efficiency is changed according to an incident angle. As the incident angle is increased, the reflecting efficiency is lowered.

Referring to FIG. 1, at an upper side of the touch panel 100, first and second emitting parts 410 and 420 are disposed to be spaced apart from each other. The first emitting part 410 is disposed at a left corner portion of the upper side, and the second emitting part 420 is disposed at a right corner portion of the upper side. The first and second emitting parts 410 and 420 radiate light to the retro-reflective tap 200, 310, 320. The light may be infrared ray. The first and second emitting parts 410 and 420 may have an emitting angle of 90° so as to emit the light to the lower and right sides and the lower and left sides without being rotated.

Referring to FIG. 1, a first light receiving part 510 is disposed at the upper left corner portion of the touch panel 100, and a second light receiving part 520 is disposed at the upper right corner portion of the touch panel 100. The first light receiving part 510 is layered with the first emitting part 410 in a thickness direction of the touch panel 100, and the second light receiving part 520 is layered with the second emitting part 420 in the thickness direction of the touch panel 100. The first light receiving part 510 functions to receive a first light emitted from the first emitting part 410 and reflected by the retro-reflective tape 200, 310, 320, and the second light receiving part 520 functions to receive a second light emitted from the second emitting part 420 and reflected by the retro-reflective tape 200, 310, 320. The first and second light receiving parts 510 and 520 may have a light receiving angle of 90° so as to receive the light from the lower and right sides and the lower and left sides without being rotated.

Referring to FIG. 1, the first light receiving part 510 is connected with a first detecting part 610. The first detecting part 610 functions to detect a first touch angle θ₁° that the first light forms with respect to a first base line 110 as a straight line passing through the first emitting part 410, when the first light is blocked by a touch object T contacted with the touch panel 100. The first base line 110 may be a left short side of the touch panel 100.

Referring to FIG. 1, the second light receiving part 520 is connected with a second detecting part 620. The second detecting part 620 functions to detect a second touch angle θ₂° that the second light forms with respect to a second base line 120 as a straight line passing through the second emitting part 420, when the second light is blocked by the object T contacted with the touch panel 100. The second base line 120 may be a right short side of the touch panel 100.

Referring to FIG. 1, the first and second detecting parts 610 and 620 are connected with a calculating part 700. The calculating part 700 functions to calculate a position of the object T by using a distance between the first and second emitting parts 410 and 420, and the first and second touch angles θ₁° and θ₂°.

In FIG. 1, the object T is spaced apart from the left short side of the touch panel 100 by a distance X₁, and also spaced apart from the lower side of the touch panel 100 by a distance Y₁.

As described above, the length of the long side of the touch panel 100 is L₁, and the length of the short side of the touch panel 100 is H₁.

Therefore, an equation 1 is obtained from an equation of X₁ tan(90°−θ₁°)=(L₁−X₁)tan(90°−θ₂°):

X₁=L₁/{tan(90°−θ₁°)tan θ₂°+1}. [Equation 1]

Further, assuming that a distance from the upper side of the touch panel 100 to the object T is Y₁′, because of Y₁′=X₁ tan(90°−θ₁°) and Y₁=H₁−Y₁′, it is possible to obtain an equation 2 as follows:

Y₁=H₁−X₁ tan(90°−θ₁°) [Equation 2]

In other words, the calculating part 700 calculates the position of the object T using the equations 1 and 2.

Referring to FIG. 2, the retro-reflective tape 200, 310, 320 includes a saw-like reflecting part 200, a left short side reflecting part 310 and a right short side reflecting part 320.

Referring to FIG. 2, the saw-like reflecting part 200 is disposed at the lower side of the touch panel 100 to which the first and second lights are incident.

Referring to FIG. 2, the saw-like reflecting part 200 is formed into a saw shape in which a first inclined surface 201 and a second inclined surface 202 are arranged alternately. Each first inclined surface 201 is inclined toward the second emitting part 420 so that an incident angle with respect to the second light is 90°, and each second inclined surface 202 is inclined toward the first emitting part 410 so that an incident angle with respect to the first light is 90°.

Therefore, the first inclined surface 201 functions as an exclusive reflecting surface for the first emitting part 410, and the second inclined surface 202 functions as an exclusive reflecting surface for the second emitting part 420.

Meanwhile, reflection efficiency of the retro-reflective tape is changed according to an incident angle. That is, as the incident angle is increased, the reflection efficiency is deteriorated. Assuming that the touch panel has a rectangular shape of which the upper and lower sides are long and the right and left sides are short, the first emitting part is disposed at the upper left corner portion, the second emitting part is disposed at the upper right corner portion, and a flat retro-reflective tape not having the saw shape is disposed at the lower side of the touch panel, the incident angle, at which the light emitted from the first and second emitting parts is incident to the retro-reflective tape disposed at the lower side of the touch panel, is changed according to an aspect ratio thereof. If the aspect ratio is 4:3, the incident angles that the light is incident to the retro-reflective tape disposed at the lower side of the touch panel are within a range of 0°˜53.2°, and if the aspect ratio is 16:9, the incident angles are within a range of 0°˜60.7°. Only when a reflection signal which is recognized by the light receiving part is generated within the entire range of the incident angle, the touch point of the touch panel can be detected.

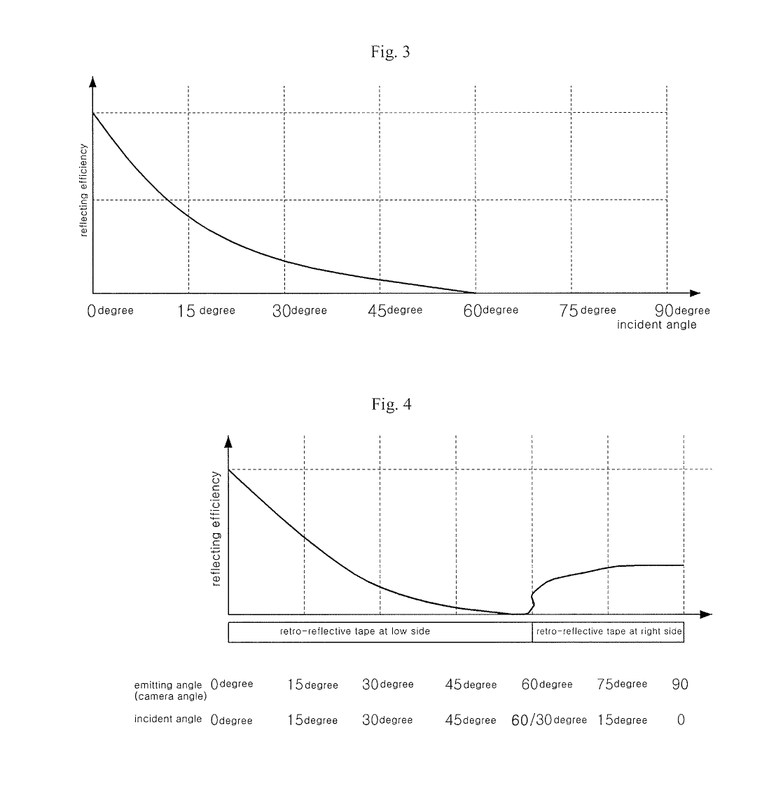

FIG. 3 is a graph showing the reflection efficiency of a representative retro-reflective tape. Referring to FIG. 3, the reflection efficiency is sharply reduced from an incident angle of 30°, and the reflection efficiency is hardly generated at an incident angle of 60°.

FIG. 4 is a graph showing a reflection efficiency of light radiated from a first emitting part, wherein an aspect ratio is 16:9, the first emitting part is disposed at an upper left corner, and a flat retro-reflective tape is disposed at low and right sides. Referring to FIG. 4, since the quantity of light which is emitted from the first emitting part and arrived at the retro-reflective tape is inversely proportional to a distance or a square of the distance (it differs according to a degree of light condensation), at the lower right corner portion of the touch panel, the incident angle is the largest (about 60°) and the distance from the first emitting part is the farthest. Therefore, the reflection efficiency is further deteriorated due to the two effects.

As a result, when the flat retro-reflective tape is attached to the touch panel, only the touch panel having an aspect ratio of 4:3 so that the incident angle is not more than about 55° is available. Accordingly, it is not possible to manufacture a wide touch panel having an aspect ratio of 16:9. Furthermore, even though the touch panel has the aspect ratio of 4:3, the reflection efficiency is lowered as a size of the touch panel is increased, and thus the size thereof is limited.

Referring to FIG. 2, however, in the first embodiment, the incident angle of the first light which is incident to the first inclined surface 201 disposed at the left corner portion of the lower side of the touch panel 100 and the first inclined surface 201 disposed at the right corner portion of the lower side of the touch panel 100 is much less than 55°, and thus there is an advantage that the reflection efficiency is increased. In the same manner, since the incident angle of the second light which is incident to the second inclined surface 202 disposed at the left corner portion of the lower side of the touch panel 100 and the second inclined surface 202 disposed at the right corner portion of the lower side of the touch panel 100 is much less than 55°, there is an advantage that the reflection efficiency is increased. Therefore, it is possible to manufacture a wide touch panel having the aspect ratio of 16:9.

In addition, referring to FIG. 2, in the first embodiment, since the second inclined surface 202 is inclined toward the first emitting part 410, the first light emitted from the first emitting part 410 is reflected by only the first inclined surface 201 having a small incident angle with respect to the first light. Therefore, if the object T (referring to FIG. 1) is placed at a first area S1 (referring to FIG. 1) of the touch panel, it is possible to exactly detect a first touch angle θ₁° regardless of the position. In other words, if the second inclined surface 202 is not inclined toward the first emitting part 410, the first light emitted from the first emitting part 410 is reflected by the second inclined surface 202 and received in the first light receiving part 510. At this time, since the reflection efficiency of the first light reflected from the second inclined surface 202 is small, there is a problem that the first detecting part 610 (referring to FIG. 1) may erroneously recognize as if there is a touch object T and thus detect an incorrect first touch angle θ₁°.

In the same way, referring to FIG. 2, in the first embodiment, since the first inclined surface 201 is inclined toward the second emitting part 420, the second light emitted from the second emitting part 420 is reflected by only the second inclined surface 201 having a small incident angle with respect to the second light. Therefore, if the object T (referring to FIG. 1) is placed at the first area S1 (referring to FIG. 1) of the touch panel, it is possible to exactly detect a second touch angle θ₂° regardless of the position. In other words, if the first inclined surface 201 is not inclined toward the second emitting part 420, the second light emitted from the second emitting part 420 is reflected by the first inclined surface 201 and received in the second light receiving part 520. At this time, since the reflection efficiency of the second light reflected from the first inclined surface 201 is small, there is a problem that the second detecting part 620 (referring to FIG. 1) may erroneously recognize as if there is a touch object T and thus detect an incorrect second touch angle θ₂°.

Referring to FIG. 2, a right short side reflecting part 320 is disposed at the right short side of the touch panel 100 to which the first light is incident but the second light is not incident.

Referring to FIG. 2, the right short side reflecting part 320 may be formed into a saw shape in which a first inclined surface 321 and a first dummy inclined surface 322 are arranged alternately. Each first dummy inclined surface 322 is inclined toward the first emitting part 410 so that an incident angle with respect to the first light is 90°, and each first inclined surface 321 is alternately arranged together with the first dummy inclined surface 322 so that the right short side reflecting part 320 has the saw shape. Meanwhile, referring to FIG. 4, in the touch panel 100 having an aspect ratio of 16:9, even though the flat retro-reflective tape is disposed at the right short side of the touch panel 100, the incident angle of the first light is 30° at the most, which is much less than 55°. Therefore, the flat retro-reflective tape is disposed at the whole right short side reflecting part 320.

Referring to FIG. 2, a left short side reflecting part 310 is disposed at the left short side of the touch panel 100 to which the second light is incident but the first light is not incident.

Referring to FIG. 2, the left short side reflecting part 310 may be formed into the saw shape in which a second inclined surface 312 and a second dummy inclined surface 311 are arranged alternately. Each second dummy inclined surface 311 is inclined toward the second emitting part 420 so that an incident angle with respect to the second light is 90°, and each second inclined surface 312 is alternately arranged together with the second dummy inclined surface 311 so that the left short side reflecting part 310 has the saw shape. Meanwhile, in the touch panel 100 having an aspect ratio of 16:9 like in the right short side reflecting part 320, even though the flat retro-reflective tape is disposed at the left short side of the touch panel 100, the incident angle of the second light is 30° at the most, which is much less than 55°. Therefore, the flat retro-reflective tape is disposed at the whole left short side reflecting part 310.

Accordingly, in the first embodiment, since the saw-like reflecting part 200 is disposed at the lower side of the touch panel 100 to which all of the first and second lights are incident, it is possible to provide an apparatus for detecting a touch point of a touch panel which can overcome the restrictions in an aspect ratio and a size of the touch panel 100.

### Second Embodiment

The second embodiment of the present invention relates to another apparatus for detecting a touch point of a touch panel using a retro-reflective tape according to the present invention.

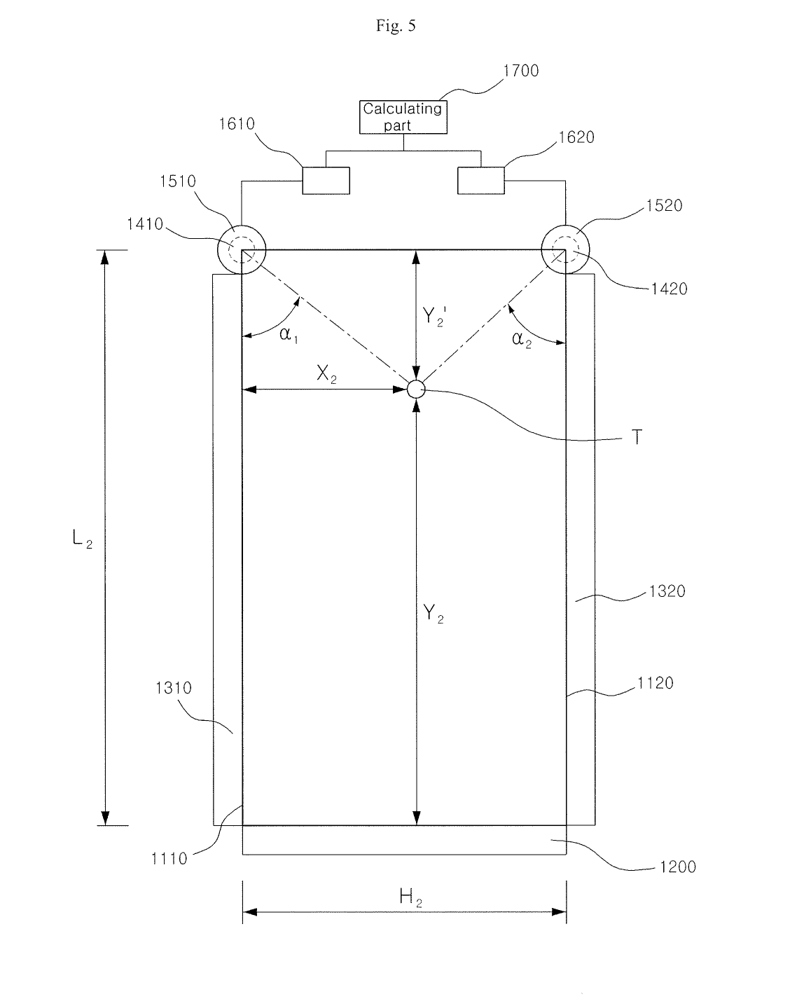

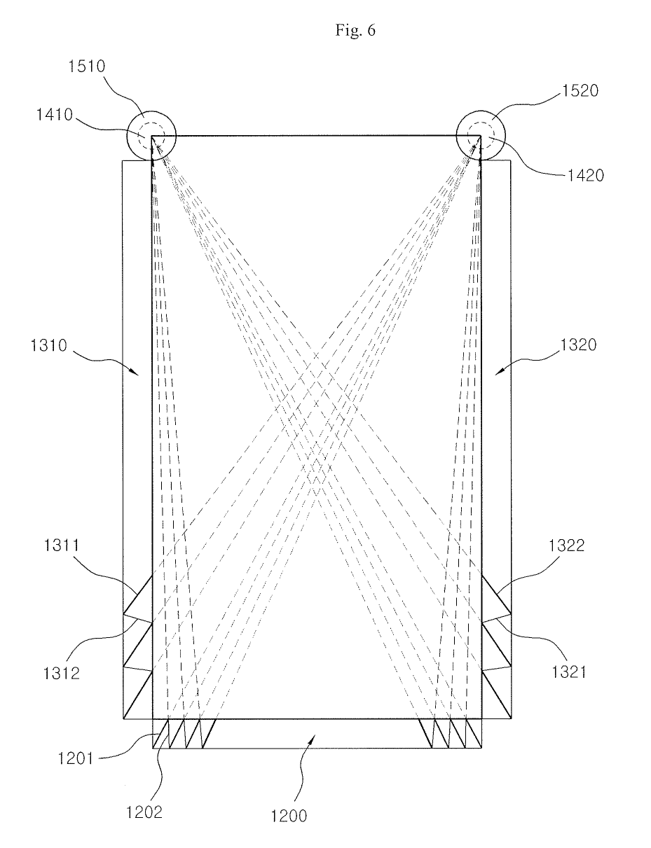

FIG. 5 is a schematic view according to a second embodiment of the present invention, and FIG. 6 is a partially enlarged view of a retro-reflective tape according to the second embodiment of the present invention.

Referring to FIG. 5, the second embodiment includes a touch panel 1100. The touch panel 1100 is formed into a rectangular shape in which right and left sides are long, and upper and lower sides are short. A length of the long side is designated by L₂, and a length of the short side is designated by H₂. Meanwhile, an aspect ratio L₂:H² may be 16:9.

Referring to FIG. 5, a retro-reflective tape 1200, 1310, 1320 is disposed at a peripheral portion of the touch panel 1100.

Referring to FIG. 5, at an upper side of the touch panel 1100, first and second emitting parts 1410 and 1420 are disposed to be spaced apart from each other. The first emitting part 1410 is disposed at a left corner portion of the upper side, and the second emitting part 1420 is disposed at a right corner portion of the upper side. A first light is emitted from the first emitting part 1410, and a second light is emitted from the second emitting part 1420.

Referring to FIG. 5, a first light receiving part 1510 is disposed at the upper left corner portion of the touch panel 1100, and a second light receiving part 1520 is disposed at the upper right corner portion of the touch panel 1100.

Referring to FIG. 5, the first light receiving part 1510 is connected with a first detecting part 1610. The first detecting part 1610 functions to detect a first touch angle α₁° that the first light forms with respect to a first base line 1110 as a straight line passing through the first emitting part 1410, when the first light is blocked by a touch object T contacted with the touch panel 1100. The first base line 1110 may be a left long side of the touch panel 1100.

Referring to FIG. 5, the second light receiving part 1520 is connected with a second detecting part 1620. The second detecting part 1620 functions to detect a second touch angle α₂° that the second light forms with respect to a second base line 1120 as a straight line passing through the second emitting part 1420, when the second light is blocked by the object T contacted with the touch panel 1100. The second base line 120 may be a right long side of the touch panel 1100.

Referring to FIG. 5, the first and second detecting parts 1610 and 1620 are connected with a calculating part 1700. The calculating part 1700 functions to calculate a position of the object T by using a distance between the first and second emitting parts 1410 and 1420, and the first and second touch angles α₁° and α₂°.

In FIG. 5, the object T is spaced apart from the left long side of the touch panel 1100 by a distance X₂, and also spaced apart from the lower side of the touch panel 1100 by a distance Y₂.

As described above, the length of the long side of the touch panel 1100 is L₂, and the length of the short side of the touch panel 1100 is H₂.

Therefore, an equation 3 is obtained from an equation of X₂ tan(90°−α₁°)=(H₂−X₂)tan(90°−α₂°):

X₂=H₂/{tan(90°−α₁°)tan α₂°+1}. [Equation 3]

Further, assuming that a distance from the upper side of the touch panel 1100 to the object T is Y₂′, because of Y₂′=X₂ tan(90°−α₁°) and Y₂=L₂−Y₂′, it is possible to obtain an equation 4 as follows:

Y₂=L₂−X₂ tan(90°−α₁°) [Equation 4]

In other words, the calculating part 1700 calculates the position of the object T using the equations 3 and 4.

Referring to FIG. 6, the retro-reflective tape 1200, 1310, 1320 includes a lower short side reflecting part 1200, second saw-like reflecting part 1310 and a first saw-like reflecting part 1320.

Referring to FIG. 6, the lower short side reflecting part 1200 is disposed at the lower side of the touch panel 1100 to which the first and second lights are incident. The lower short side reflecting part 1200 may is the same type as the saw-like reflecting part 200 of the first embodiment. That is, the lower short side reflecting part 1200 is formed into a saw shape in which a first inclined surface 1201 and a second inclined surface 1202 are arranged alternately. Each first inclined surface 1201 is inclined toward the second emitting part 1420 so that an incident angle with respect to the second light is 90°, and each second inclined surface 1202 is inclined toward the first emitting part 1410 so that an incident angle with respect to the first light is 90°. Therefore, the first inclined surface 1201 functions as an exclusive reflecting surface for the first emitting part 1410, and the second inclined surface 1202 functions as an exclusive reflecting surface for the second emitting part 1420. meanwhile, in case that the touch panel 1100 has an aspect ratio of 16:9 and the first and second emitting part 1410 and 1420 are disposed at the left and right corner portions of the upper short side of the touch panel 1100, even though the flat retro-reflective tape is disposed at the lower short side of the touch panel 1100, the incident angles of the first and the second light are 30° at the most, which is much less than 55°. Therefore, the flat retro-reflective tape may be disposed at the whole lower short side reflecting part 1200.

Referring to FIG. 6, the first saw-like reflecting part 1320 is disposed at the right long side of the touch panel 1100 to which the first light is incident but the second light is not incident.

Referring to FIG. 6, the first saw-like reflecting part 1320 may be formed into a saw shape in which a first inclined surface 1321 and a first dummy inclined surface 1322 are arranged alternately. Each first dummy inclined surface 1322 is inclined toward the first emitting part 1410 so that an incident angle with respect to the first light is 90°, and each first inclined surface 1321 is alternately arranged together with the first dummy inclined surface 1322 so that the right short side reflecting part 1320 has the saw shape.

Referring to FIG. 6, the second saw-like reflecting part 1310 is disposed at the left long side of the touch panel 1100 to which the second light is incident but the first light is not incident.

Referring to FIG. 6, the second saw-like reflecting part 1310 may be formed into a saw shape in which a second inclined surface 1312 and a second dummy inclined surface 1311 are arranged alternately. Each second dummy inclined surface 1311 is inclined toward the second emitting part 1420 so that an incident angle with respect to the second light is 90°, and each second inclined surface 1312 is alternately arranged together with the second dummy inclined surface 1311 so that the second saw-like reflecting part 1310 has the saw shape.

Accordingly, in the second embodiment, since the first and second saw-like reflecting parts 1320 and 1310 are respectively disposed at the right and left long sides of the touch panel 100 to which only one of the first and second lights is incident, it is possible to provide an apparatus for detecting a touch point of a touch panel which can overcome the restrictions in an aspect ratio and a size of the touch panel 1100.

Other parts which are not described here are based on the first embodiment.

### Third Embodiment

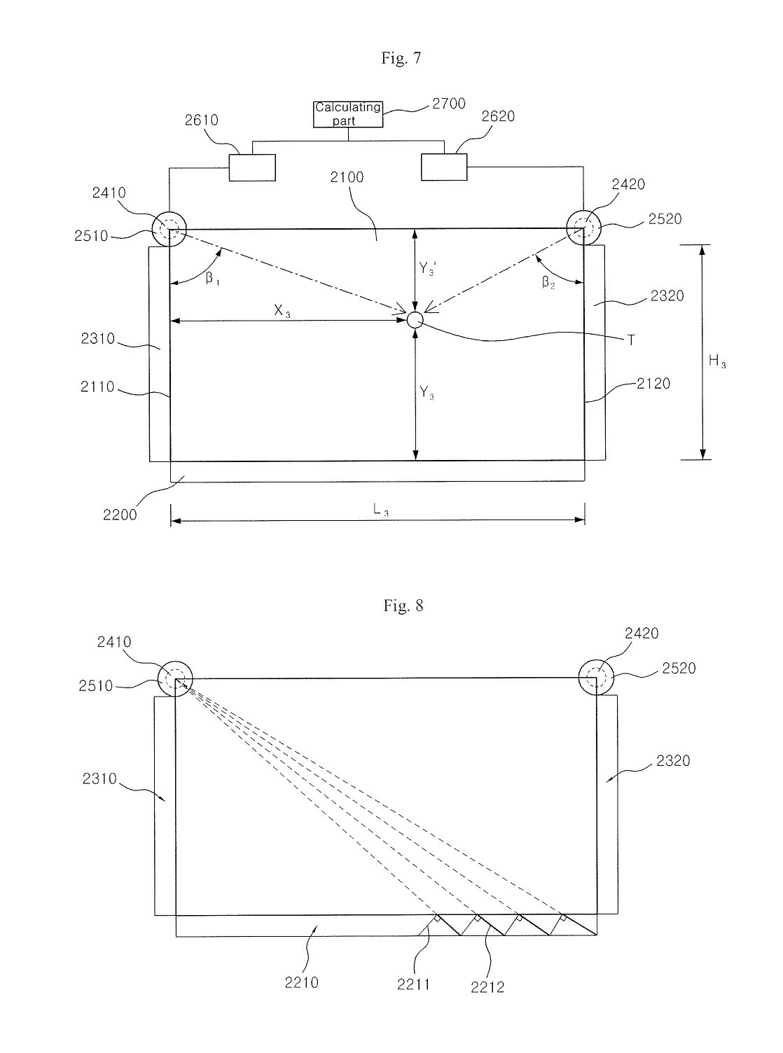

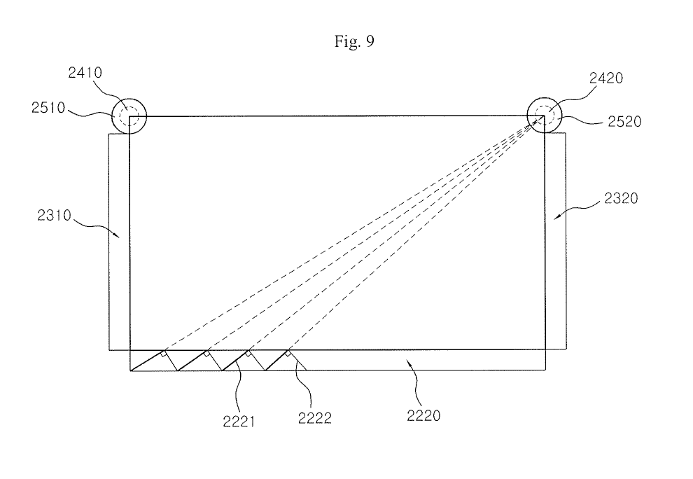

FIG. 7 is a schematic view according to a third embodiment of the present invention, FIG. 8 is a partially enlarged view of a first saw-like reflecting part according to the third embodiment of the present invention, and FIG. 9 is a partially enlarged view of a second saw-like reflecting part according to the third embodiment of the present invention.

Referring to FIG. 7, the third embodiment includes a touch panel 2100. The touch panel 2100 is formed into a rectangular shape in which upper and lower sides are long, and right and left sides are short. A length of the long side is designated by L₃, and a length of the short side is designated by H₃. Meanwhile, an aspect ratio L₃:H₃ may be 16:9.

Referring to FIG. 7, a retro-reflective tape 2200, 2310, 2320 is disposed at a peripheral portion of the touch panel 2100.

Referring to FIG. 7, at an upper side of the touch panel 2100, first and second emitting parts 2410 and 2420 are disposed to be spaced apart from each other. The first emitting part 2410 is disposed at a left corner portion of the upper side of the touch panel 2100, and the second emitting part 2420 is disposed at a right corner portion of the upper side thereof. The first emitting part 1410 emits a first light, and the second emitting part 1420 emits a second light.

Referring to FIG. 7, a first light receiving part 2510 is disposed at the upper left corner portion of the touch panel 2100, and a second light receiving part 2520 is disposed at the upper right corner portion of the touch panel 100.

Referring to FIG. 7, the first light receiving part 2510 is connected with a first detecting part 2610. The first detecting part 2610 functions to detect a first touch angle β₁° that the first light forms with respect to a first base line 2110 as a straight line passing through the first emitting part 2410, when the first light is blocked by a touch object T contacted with the touch panel 2100. The first base line 2110 may be a left short side of the touch panel 2100.

Referring to FIG. 7, the second light receiving part 2520 is connected with a second detecting part 2620. The second detecting part 2620 functions to detect a second touch angle β₂° that the second light forms with respect to a second base line 2120 as a straight line passing through the second emitting part 2420, when the second light is blocked by the object T contacted with the touch panel 2100. The second base line 2120 may be a right short side of the touch panel 2100.

Referring to FIG. 7, the first and second detecting parts 2610 and 2620 are connected with a calculating part 2700. The calculating part 2700 functions to calculate a position of the object T by using a distance between the first and second emitting parts 2410 and 2420, and the first and second touch angles β₁° and β₂°.

In FIG. 7, the object T is spaced apart from the left short side of the touch panel 2100 by a distance X₃, and also spaced apart from the lower side of the touch panel 2100 by a distance Y₃.

As described above, the length of the long side of the touch panel 100 is L₃, and the length of the short side of the touch panel 100 is H₃.

Therefore, an equation 5 is obtained from an equation of X₃ tan(90°−β₁°)=(L₃−X₃)tan(90°−β₂°):

X₃=L₃/{tan(90°−β₁°)tan β₂°+1}. [Equation 5]

Further, assuming that a distance from the upper side of the touch panel 2100 to the object T is Y₃′, because of Y₃′=X₃ tan(90°−β₁°) and Y₃=H₃−Y₃′, it is possible to obtain an equation 6 as follows:

Y₃=H₃−X₃ tan(90°−β₁°) [Equation 6]

In other words, the calculating part 2700 calculates the position of the object T using the equations 5 and 6.

Referring to FIG. 7, the retro-reflective tape 2200, 2310, 2320 includes a saw-like reflecting part 2200, a left short side reflecting part 2310 and a right short side reflecting part 2320.

The saw-like reflecting part 2200 is disposed at the lower side of the touch panel 2100 to which all of the first and second lights are incident.

Referring to FIGS. 8 and 9, the saw-like reflecting part 2200 includes a first saw-like reflecting part 2210 and a second saw-like reflecting part 2220 which is layered with the first saw-like reflecting part 2210 in a thickness direction of the touch panel 2100. That is, the first and second saw-like reflecting parts 2210 and 2220 are layered with each other in a vertical direction to the ground of FIGS. 8 and 9.

Referring to FIGS. 8, the first saw-like reflecting part 2210 is formed into a saw shape in which a first inclined surface 2211 and a first dummy inclined surface 2212 are arranged alternately. Each first dummy inclined surface 2212 is inclined toward the first emitting part 2410 so that an incident angle with respect to the first light is 90°, and each first inclined surface 2211 is alternately arranged together with the first dummy inclined surface 2212 so that the first saw-like reflecting part 2210 has the saw shape. Preferably, the first saw-like reflecting part 2210 is formed so that the incident angle of the first light which is incident to a desired portion of the first inclined surface 2211 is 90°. An angle of a contacted portion of the first dummy inclined surface 2212 and the first inclined surface 2211 may be 90°. Meanwhile, unlike in the first embodiment, the first inclined surface 2211 may be not inclined toward the second emitting part 2420. In this case, the second light is incident to the first inclined surface 2211 and then reflected to the second light receiving part 2520. However, at this time, the incident angle of the second light which is incident to the first inclined surface 2211 may be much more than 55°, and thus the second detecting part 2620 connected with the second light receiving part 2520 may erroneously recognize the second touch angle β₂° of the touch object T. Therefore, in order to solve the problem that the second detecting part 2620 erroneously recognizes the second touch angle β₂° of the touch object T, the third embodiment of the present invention further includes the second saw-like reflecting part 2220 which is layered with the first saw-like reflecting part 2210.

Referring to FIG. 9, the second saw-like reflecting part 2220 is formed into a saw shape in which a second inclined surface 2222 and a second dummy inclined surface 2221 are arranged alternately. Each second dummy inclined surface 2221 is inclined toward the second emitting part 2420 so that an incident angle with respect to the second light is 90°, and each second inclined surface 2222 is alternately arranged together with the second dummy inclined surface 2221 so that the second saw-like reflecting part 2220 has the saw shape. Preferably, the second saw-like reflecting part 2220 is formed so that the incident angle of the second light which is incident to a desired portion of the second inclined surface 2222 is 90°. An angle of a contacted portion of the second dummy inclined surface 2221 and the second inclined surface 2222 may be 90°. Meanwhile, unlike in the first embodiment, the second inclined surface 2222 may be not inclined toward the first emitting part 2410. In this case, the first light is incident to the second inclined surface 2222 and then reflected to the first light receiving part 2510. However, at this time, the incident angle of the first light which is incident to the second inclined surface 2222 may be much more than 55°, and thus the first detecting part 2610 connected with the first light receiving part 2510 may erroneously recognize the first touch angle β₁° of the touch object T. But this problem is solved by the first saw-like reflecting part 2210 which is layered with the second saw-like reflecting part 2220. In case that the first and second saw-like reflecting parts 2210 and 2220 are symmetric with each other, a thickness thereof is the same.

Referring to FIG. 2, the right short side reflecting part 2320 is disposed at the right short side of the touch panel 2100 in which the first right is incident but the second right is not incident. The left short side reflecting part 2310 is disposed at the left short side of the touch panel 2100 in which the second right is incident but the first right is not incident. Since the right short side reflecting part 2320 is the same as the right short side reflecting part 320 of the first embodiment, and the left short side reflecting part 2310 is the same as the left short side reflecting part 310 of the first embodiment, descriptions thereof will be omitted.

Therefore, in the third embodiment, since the first saw-like reflecting part 2210 and the second saw-like reflecting part 2200 which is layered with the first saw-like reflecting part 2210 are disposed at the lower side of the touch panel 2100 to which all of the first and second lights are incident, it is possible to provide an apparatus for detecting a touch point of a touch panel which can overcome the restrictions in an aspect ratio and a size of the touch panel 100.

The present application contains subject matter related to Korean Patent Application No. 2009-0010209, filed in the Korean Intellectual Property Office on Feb. 9, 2009, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

According to the present invention, since a whole or part of the retro-reflective tape which is used in the infrared background of the reflective camera type touch panel to reflect the infrared rays is formed into a saw shape, it is possible to overcome the restrictions in an aspect ratio and a size of the touch panel and embodying the touch panel having various aspect ratios and sizes.

1. An apparatus for detecting a touch point of a touch panel, comprising:
a retro-reflective tape which is disposed at a peripheral portion of the touch panel;
first and second emitting parts which are spaced apart from each other at one side of the touch panel so as to radiate light to the retro-reflective tape;
a first light receiving part which receives a first light emitted from the first emitting part and reflected by the retro-reflective tape;
a first detecting part which is connected with the first light receiving part so as to detect a first touch angle θ₁° that the first light forms with respect to a first base line as a straight line passing through the first emitting part, when the first light is blocked by a touch object T contacted with the touch panel;
a second light receiving part which receives a second light emitted from the second emitting part and reflected by the retro-reflective tape;
a second detecting part which is connected with the second light receiving part so as to detect a second touch angle θ₂° that the second light forms with respect to a second base line as a straight line passing through the second emitting part, when the second light is blocked by the touch object T contacted with the touch panel; and
a calculating part which calculates a position of the touch object T using a distance between the first and second emitting part and the first and second touch angles θ₁° and θ₂°,
wherein the retro-reflective tape comprises a saw-like reflecting part which is disposed at a side of the touch panel to which the first and second lights are incident, and which comprises a first inclined surface which is inclined toward the second emitting part so that an incident angle with respect to the second light is 90°, a second inclined surface which is inclined toward the first emitting part so that an incident angle with respect to the first light is 90° and alternately disposed together with the first inclined surface so as to form a saw shape.

2. The apparatus of claim 1, wherein the first emitting part and the first light receiving part are disposed at one corner portion of one long side of the rectangular touch panel, the second emitting part and the second light receiving part are disposed at the other corner portion of the long side of the touch panel, and the saw-like reflecting part is disposed at the other long side of the touch panel.

3. The apparatus of claim 2, wherein the first base line is one short side of the touch panel passing through the first emitting part, and the second base line is the other short side of the touch panel passing through the second emitting part.

4. The apparatus of claim 3, wherein an aspect ratio of the touch panel is 16:9.

5. An apparatus for detecting a touch point of a touch panel, comprising:
a retro-reflective tape which is disposed at a peripheral portion of the touch panel;
first and second emitting parts which are spaced apart from each other at one side of the touch panel so as to radiate light to the retro-reflective tape;
a first light receiving part which receives a first light emitted from the first emitting part and reflected by the retro-reflective tape;
a first detecting part which is connected with the first light receiving part so as to detect a first touch angle β₁° that the first light forms with respect to a first base line as a straight line passing through the first emitting part, when the first light is blocked by a touch object T contacted with the touch panel;
a second light receiving part which receives a second light emitted from the second emitting part and reflected by the retro-reflective tape;
a second detecting part which is connected with the second light receiving part so as to detect a second touch angle β₂° that the second light forms with respect to a second base line as a straight line passing through the second emitting part, when the second light is blocked by the touch object T contacted with the touch panel; and
a calculating part which calculates a position of the touch object T using a distance between the first and second emitting part and the first and second touch angles β₁° and β₂°,
wherein the retro-reflective tape comprises: a first saw-like reflecting part which is disposed at a side that the first and second lights are incident and which has a first dummy inclined surface which is inclined toward the first emitting part so that an incident angle with respect to the first light is 90°, and a first inclined surface which is alternately disposed with the first dummy inclined surface to form a saw shape, so that an incident angle with respect to the first light is 0° at at least a part of the first inclined surface, and
a second saw-like reflecting part which is layered with the first saw-like reflecting part in a thickness direction and which has a second dummy inclined surface which is inclined toward the second emitting part so that an incident angle with respect to the second light is 90°, and a second inclined surface which is alternately disposed with the second dummy inclined surface to form a saw shape, so that an incident angle with respect to the second light is 0° at at least a part of the first inclined surface.

6. The apparatus of claim 5, wherein the first saw-like reflecting part is formed so that an angle of a contacted portion of the first dummy inclined surface and the first inclined surface may be 90°, and
the second saw-like reflecting part is formed so that an angle of a contacted portion of the second dummy inclined surface and the second inclined surface may be 90°.
